(19) United States
(12) Patent Application Publication
(10) Pub. No.: US 2015/0336416 A1
(43) Pub. Date: Nov. 26, 2015

(54) PRINT PRODCUT WITH ACCESS CODE

(71) Applicant: manroland web systems GmbH, Augsburg (DE)

(72) Inventors: Thomas EISENSTEGER, Augsburg (DE); Peter Schulmeister, Pfaffenhofen (DE)

(73) Assignee: manroland web systems GmbH, Augsburg (DE)

(21) Appl. No.: 14/720,371

(22) Filed: May 22, 2015

(30) Foreign Application Priority Data
May 26, 2014 (DE) 10 2014 107 376.2

(51) Int. Cl. B42D 25/27; B42D 25/20; B41F 11/00

(52) U.S. Cl. CPC B42D 25/27; B41F 11/00; B42D 25/20

(57) ABSTRACT

A method for producing a print product with an access code in a reel-fed rotary printing press is disclosed. The access code is printed in a code region on a first sheet of the print product where the access code is to be particularly well protected against illegitimate extraction or viewing by third parties. Furthermore, the buyer of such a print product with an access code is to be able to particularly easily detect if attempts were made by third parties to view this access code. For this purpose, the code region is covered by a viewing safeguard in such a manner that the viewing safeguard can only be irreparably removed.

This application claims the priority of German Patent Document No. DE 10 2014 107 376.2, filed May 26, 2014, the disclosure of which is expressly incorporated by reference herein.

### BACKGROUND AND SUMMARY OF THE INVENTION

The invention relates to a method for producing a print product with an access code in a reel-fed rotary printing press, where the access code is printed in a code region on a first sheet of the print product. The invention furthermore relates to a reel-fed printing press for producing such a print product and to a print product with an access code.

The term access code in this case stands synonymous for an individualized feature which is generally printed on. The access code can, for example, be connection codes, voucher codes, personal identification numbers, competition codes or ticket numbers.

In the case of reel-fed printing systems with non-variable print form, i.e., offset, intaglio or flexographic printing presses, in particular in the case of newspaper reel-fed offset printing presses, inkjet printing heads for printing invariable or individualized (=print from variable) contents are increasingly employed. Such applications are described for example in the publications WO2005/068197 A1 or DE 10 2006 016 065 A1.

Furthermore it is described for example in WO2009/003607 how inkjet printing heads, which are normally designed for substantially lower print speeds than is usual in reel-fed offset printing, can be employed even at high print speeds of maximally approximately 15 m/s by adapting the maximum resolution. The adequately accurate positioning of the imprints is covered by DE 10 2007 047 180 A1, so that the inkjet imprint can be positioned with adequate accuracy in the static print image even with the maximum speeds of reel-fed offset printing in the tenth of a millimetre range. Such inkjet imprints can thus be employed in personalized issues or in smallest editions with regional particularities, etc.

PCT/EP2008/008222 (WO2009/043553) furthermore describes a method with which individual access data, such as, for example, win codes can be printed onto a statically printed web by print form-less printing devices in line at least for some print copies.

These technical possibilities render such applications ever more economical and thus more attractive so that such methods are already increasingly employed.

Accordingly, several daily newspapers already utilize the steps described above in order to increase the attractiveness of the printed information carriers by way of competitions.

Other daily newspapers utilize individual access data printed on the (charged for) newspaper so that with this access data further information or applications can be accessed in the internet via PC, tablet PCs or Smartphones. Accordingly, internet-based information on the other hand serving the greater networking of printed and non-printed sources of information.

Such individualized access codes are usually made available online from corresponding databases and can only be activated a single time. Accordingly, following the one-off input of an individual access code the same is blocked, so that it is unusable for further inputs. The objective is that the buyer of a print medium in addition to the print product also acquires the access rights for additional contents in the internet that are not available free of charge.

Disadvantageous with this method is that to-date the individual access codes imprinted with the inject methods are easily accessible to third parties. Although the access codes are mostly not depicted on the outer pages of the print product, this individual access data however is visible when suitably paging through the newspaper, i.e., with little time expenditure, so that these codes can be viewed and redeemed even without buying the print product, in particular a newspaper.

The buyer of this newspaper, who thus legally acquires also the access code with the print product and thus the entitlement for accessing internet information or, for example, the participation in lotteries which is not free of charge, will, in the case that the access code has already been entered and thus redeemed beforehand, no longer be able to utilize the same and thus not be able to get to the information to which the buyer is entitled.

Here it is problematic in particular that in the event of a previously unauthorized utilization of the access code it is also not clear to the rightful buyer of the print product why the access code the buyer acquired cannot be utilized. Furthermore the buyer, but also the seller, of the print product is not able when respectively buying or selling the print product to check if the code has already been viewed or redeemed.

The invention is therefore based on the object of stating a method for producing a print product, a reel-fed printing press for producing a print product and a print product with an access code, with which the access code is particularly well protected against illegitimate extraction or viewing by third parties. Furthermore, the buyer of such a print product with an access code is to be able to particularly easily detect if third parties have attempted to view this access code.

According to the invention, this object is solved by covering the code region by a viewing safeguard in such a manner that the viewing safeguard can only be irreparably removed.

The invention starts out from the consideration that simple and quick illegitimate extraction or cancellation of an access code, e.g., of a connection code, a voucher code, a personal identification number, etc., can be prevented when the same is covered by a viewing safeguard. In order for the buyer of the print product to immediately detect whether attempts were made to utilize or steal the access code, the viewing safeguard is applied in such a manner that it can only be irreparably removed. By the absent or damaged viewing safeguard the buyer thus immediately detects if attempts were made to view the access code.

It is substantial to the invention that for covering the code region with a viewing safeguard devices and materials are preferably used which are usually employed in a reel-fed rotary printing press anyway. For this reason, a second sheet of the print product, usually the likewise printed neighboring sheet is used as the viewing safeguard in a preferred embodiment. In an alternative preferred embodiment, the code region is covered by a second region of the first sheet. Here, a plough fold device can be used in an advantageous embodiment, which folds this second region of the first sheet placing it over the code region.

To irreparably or irreversibly join the viewing safeguard with the code region, the viewing safeguard in a preferred embodiment is glued on the code region or the viewing safeguard is chained to the code region. Chaining is achieved in that at least two layers are jointly perforated, preferentially with a so-called book or chaining perforation. A corresponding perforating device is basically installed in every reel-fed printing press or can be retrofitted with little effort. To avoid damaging the access code through the gluing or chaining such a connection is preferentially performed in one or multiple edge regions of the code region. A clocked, punctiform or sectional application of adhesive is also possible.

In the case of covering the code region by a second sheet, the first sheet and the second sheet in a preferred embodiment are joined by a fold. This means that during the production of the print product the first and second pages were not slide open or not completely so. In an advantageous configuration, a perforation line can be provided in the region of the fold so that the two sheets can be separated without damaging the access code. When doing so, it is additionally possible for the buyer of the print product to determine if the access code has already been viewed by third parties.

In an alternative advantageous configuration, the viewing safeguard is embodied as an adhesive tape. This adhesive tape in this case can be a simple adhesive label or a two-stage adhesive tape as is employed, for example, as splice adhesive tape with reel changers. In the case of the latter, the lower side of the adhesive tape is permanently glued on the code region and on peeling off merely the covering layer of the adhesive tape detaches. These adhesive tapes can be glued over the full area or only partially, for example, in edge regions or be adhesively formed on one or multiple outer edges.

In a further alternative preferred embodiment scratch-off ink as the viewing safeguard can be applied, which can only be irreparably removed through mechanical working, for example in the form of scratching. When applying scratch-off ink, the code region in a particularly advantageous embodiment is primed beforehand so that the access code does not shine through or the scratch-off ink can be removed without damaging the access code. For this priming, UV or dispersion coatings are preferably employed. Because of the usually same position of the access code in the print product, the priming as well as the scratch-off ink can be applied with conventional coating units and/or by inkjet imprint devices.

For further avoiding quick viewing, the access code is arranged in an advantageous embodiment in the region of the fold spine about which the pages are paged through. To protect the access code, at least one further at least four-page book can be placed over, and preferentially but not mandatorily joined to, the book located below through stitching or gluing—preferentially through partial gluing—so that for viewing the access code the relevant books located above have to be removed and the newspaper for this purpose, as well as for reading the access code, has to be opened more or less completely. Generally, this is not possible without being noticed. The books located inside can be likewise stitched or glued to the print product in this case so that prior access to the access code can be unambiguously identified.

The advantages achieved with the invention consist in particular in that by covering the access code by a viewing safeguard the same cannot be easily viewed and utilized by unauthorized third parties without buying the print product. Since the viewing safeguard can only be irreparably removed, the buyer can see in the simplest of manners even before buying the print product if attempts were made to steal or cancel the access code. The buyer is to be given the possibility to remove the viewing safeguard by the buyer in a simple manner without substantially damaging the access code or the print product.

Exemplary embodiments of the invention are explained in more detail with the help of the drawings.

### BRIEF DESCRIPTION OF THE DRAWINGS

FIG. 1 illustrates a print product in which a code region is covered by a second sheet;

FIG. 2 illustrates a print product in which a code region is covered by a second region of the first sheet;

FIG. 3 illustrates a further embodiment of a print product in which a code region is covered by a second region of the sheet;

FIG. 4 illustrates a print product with a code region in the region of the fold spine; and

FIG. 5 illustrates a print product with multiple code regions.

### DETAILED DESCRIPTION OF THE DRAWINGS

The same parts are marked with the same reference numbers in all figures.

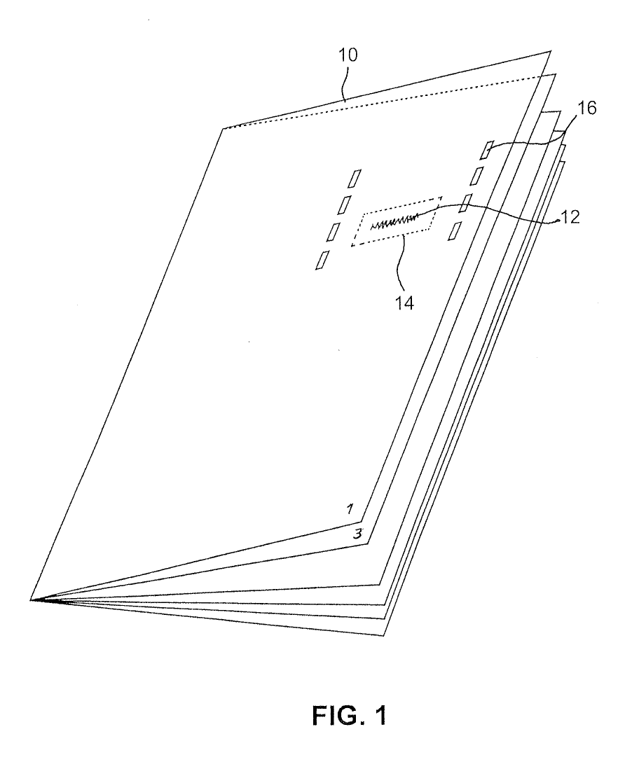

The print product 10 according to FIG. 1 is exemplarily shown as a newspaper copy, but all other print products 10, such as, for example, magazines or advertising supplements, are also conceivable, which are produced by a reel-fed rotary printing press. The print product 10 includes an access code 12, which is printed in a code region 14 on page 3 by an inkjet printing device. Here, the access code 12 is individually printed on by the inkjet printing device which means that a separate non-repetitive access code 12 is printed into each produced print product 10.

With the help of this access code 12, the buyer of the print product 10 can access additional contents, information or offers, for example, on an advertising page of the provider or by other ways. To avoid an undesirable distribution of the access codes 12 over multiple users, this access code 12 is usually designed as a one-way code which means that the offers connected with it can only be utilized once or once for a certain period of time. In order for the buyer of the print product 10, and thus of the access code 12, to be certain that the access code 12 has not been stolen and already utilized and thus cancelled by third parties, the code region 14, in which the access code 12 was printed, is covered by page 1 in the exemplary embodiment according to FIG. 1. Here, page 1 is glued to page 3 along the code region 14 or exemplarily along two pages of the code region 14 by a clocked adhesive trail 16. Thus it is not possible for third parties to view the access code 12 without leaving a visual trail in the form of a separating of the adhesive trail 16. The buyer of the print product 10 can thus immediately see if attempts were made to steal or view the access code 12.

In an alternative manner, page 1 can also be chained to page 3 in the code region 14. Viewing the access code 12 in this way is also possible only through irreparable or irreversible separating of the two pages.

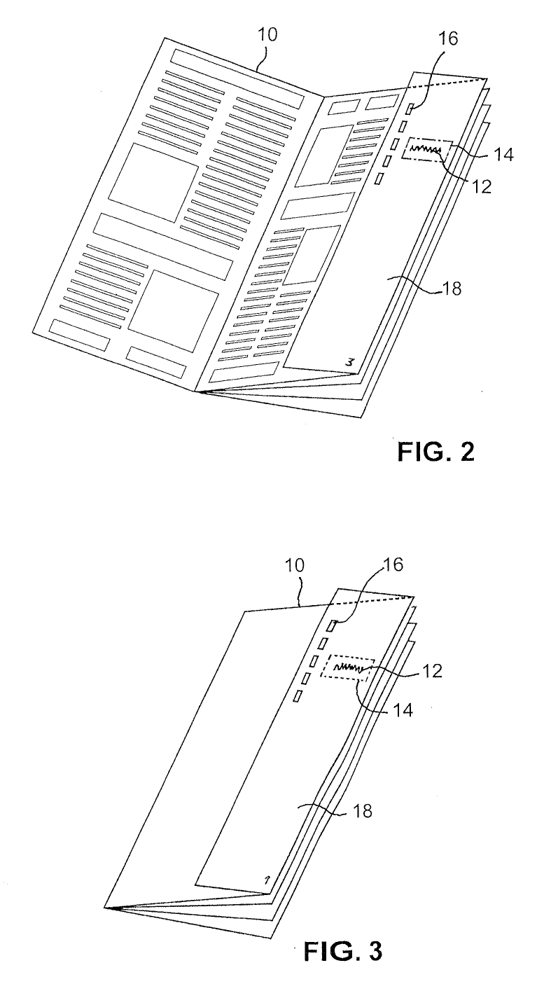

In contrast with the print product 10 according to FIG. 1, the code region, in the exemplary embodiment according to FIGS. 2 and 3, is covered by a second region 18 of the sheet on which the code region is located. Here, the edge region 18 is folded in by a plough fold device and the code region 14 is thus covered. This is possible both with a page located within the newspaper (FIG. 2) as well as with the title page (FIG. 3). With this embodiment, the folded-in viewing safeguard is joined to the page of the code region 14 by a clocked adhesive trail 16 or by chaining in such a manner that unauthorized opening of the joint is irreparable and can be detected by the buyer of the print product.

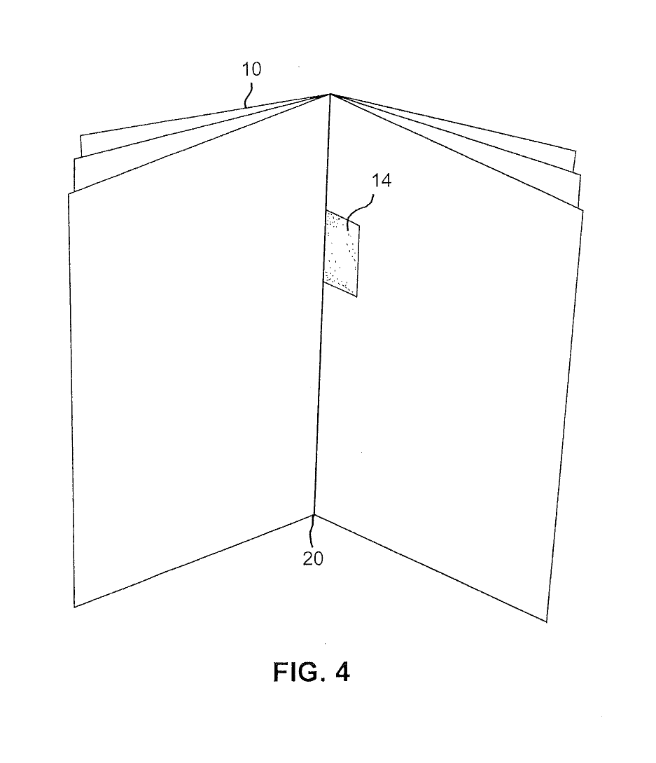

FIG. 4 shows an exemplary embodiment of the invention, in which the access code 12 or the code region 14 is arranged in the region of the fold spine 20. To remove or view the access code 12 the newspaper therefore has to be opened more or less completely, which is not usually possible without being noticed. Furthermore, the access code 12 can additionally include a viewing safeguard which is applied onto the code region 14 with one of the methods described above in such a manner that removing the viewing safeguard is visually clearly detectable. Furthermore, it is also possible with such a positioning of the code region 14 that as a viewing safeguard a book or multiple books or further print products are used which are placed, stitched or glued onto the code region 14. To view the access code 12, the newspaper thus does not only have to be completely opened, the additional book or the additional books also have to be removed.

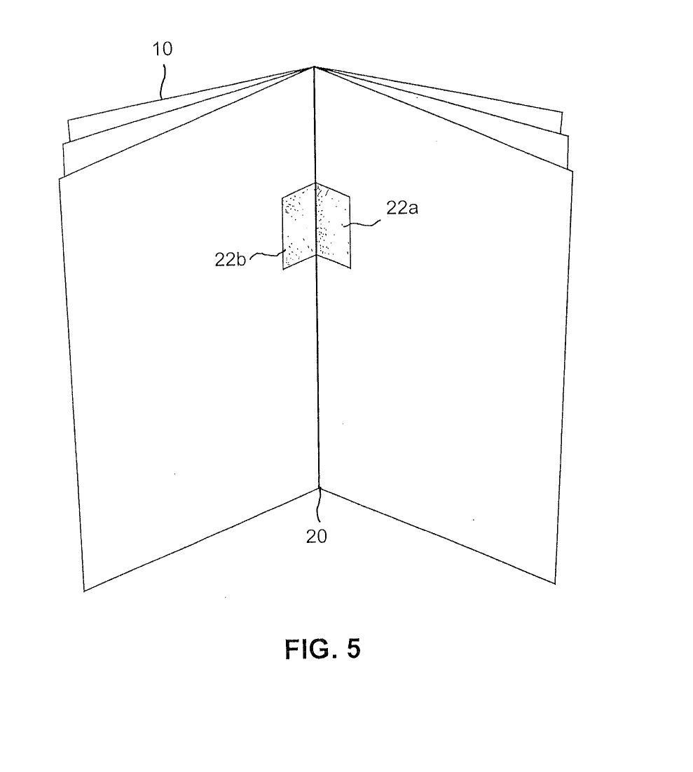

A further protection from illegitimate extraction of the access code is shown in FIG. 5. The access code 12 in this exemplary embodiment is not only arranged in a code region 14 on a sheet but in multiple code regions 22a, 22b on different sheets or pages or even in multiple code regions 22a, 22b on a sheet. The access code 12 in this case is subdivided into multiple segments which in each case are arranged printed in a separate code region 22a, 22b within the print product 10. Each of these code regions 22a, 22b can then be covered by a viewing safeguard. In the process, one of the methods described above can be used to secure the viewing safeguard.

The access code 12 in this case can also be divided in the longitudinal and/or transverse direction and these individual elements of the access code 12 can be distributed over multiple code regions 22a, 22b within the print product 10. Here, a distribution of the code regions 22a, 22b is preferred in which by folding together the print product 10 or individual sheets or pages of the print product 10 the access code 12 as a whole is rendered legible. Such a method for dividing the access code 12 over multiple code regions 22a, 22b is not only restricted to the use in reel-fed rotary printing presses.

### LIST OF REFERENCE NUMBERS

1 First page of the print product
3 Third page of the print product
10 Print product
12 Access code
14 Code region
16 Adhesive trail
18 Edge region of the sheet
20 Fold spine
22a Further code region
22b Further code region

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a print product with an access code in a reel-fed rotary printing press, comprising the steps of:
printing the access code in a code region on a first sheet of the print product; and
covering the code region by a viewing safeguard such that the viewing safeguard is only irreparably removable.

2. The method according to claim 1, wherein the viewing safeguard is a second sheet of the print product.

3. The method according to claim 1, wherein the viewing safeguard is a second region of the first sheet.

4. The method according to claim 3, wherein a plough fold device folds the second region of the first sheet.

5. The method according to claim 1, wherein the viewing safeguard is at least partially glued and/or chained to the code region.

6. The method according to claim 1, wherein the viewing safeguard is an adhesive tape.

7. The method according to claim 1, wherein the viewing safeguard is scratch-off ink.

8. The method according to claim 1, further comprising the step of priming the access code by an ultraviolet (UV) coating or a dispersion coating before covering the code region by the scratch-off ink.

9. A print product of a reel-fed rotary printing press, comprising:
an access code, wherein the access code is printed in a code region on a first sheet of the print product and wherein the code region is covered by a viewing safeguard that is only irreparably removable.

10. The print product according to claim 9, wherein the viewing safeguard is a second sheet of the print product.

11. The print product according to claim 10, wherein the first sheet and the second sheet are at least partially joined via a fold on a product edge that deviates from a fold spine.

12. The print product according to claim 9, wherein the viewing safeguard is a second region of the first sheet.

13. The print product according to claim 9, wherein the viewing safeguard is at least partially glued and/or chained to the code region.

14. The print product according to claim 9, wherein the viewing safeguard is an adhesive tape.

15. The print product according to claim 9, wherein the viewing safeguard is a scratch-off ink.

16. The print product according to claim 9, wherein the code region is disposed in a region of a fold spine of the first sheet.
